(19) United States
(12) Patent Application Publication
(10) Pub. No.: US 2020/0053231 A1
(43) Pub. Date: Feb. 13, 2020

(54) NON-TRANSITORY COMPUTER-READABLE STORAGE MEDIUM STORING TRANSMISSION SETTING APPLICATION, NON-TRANSITORY COMPUTER-READABLE STORAGE MEDIUM STORING DEVICE CONTROL PROGRAM, AND CONTROL METHOD OF COMPUTER

(71) Applicant: CANON KABUSHIKI KAISHA, Tokyo (JP)

(72) Inventor: Hiroshi Kikuchi, Toride-shi (JP)

(21) Appl. No.: 16/530,026

(22) Filed: Aug. 2, 2019

(30) Foreign Application Priority Data
Aug. 9, 2018 (JP) 2018-150642

(51) Int. Cl. H04N 1/00; G06F 3/12

(52) U.S. Cl. CPC H04N 1/00214; H04N 1/00411; G06F 3/1254; G06F 3/1205; H04N 1/00477

(57) ABSTRACT

A non-transitory computer-readable storage medium storing a transmission setting application, wherein the transmission setting application is associated with a driver generating a transmission command for transmitting data received from an application to a destination by a device is provided. The transmission setting application causes a computer to execute a first input step of causing a user to input a transmission setting of the data, a reception step of receiving the data and the transmission setting from the application that has obtained the transmission setting, a second input step of causing the user to input information indicating the destination, and a providing step of providing the information indicating the input destination, the transmission setting, and the data to the driver.

### BACKGROUND OF THE INVENTION

### Field of the Invention

The present invention relates to a non-transitory computer-readable storage medium each storing a transmission setting application, a non-transitory computer-readable storage medium storing a device control program, and a control method of a computer.

### Description of the Related Art

Generally, as a piece of software for giving an instruction of facsimile transmission (FAX transmission) from a computer to a facsimile device (FAX device), software called a facsimile driver (FAX driver, FAX drover) has been known. An operating system (OS), which is basic software, is installed in a computer. The FAX driver is designed in accordance with a specification of a printer driver defined by the OS. The difference between a general printer driver and a FAX driver lies in that input of destination information (usually, a FAX number) of FAX transmission is needed to the FAX driver. A user creates data to be transmitted by FAX transmission by using a general application, and then performs operation for printing in the application to specify a FAX driver. Accordingly, a destination input screen for FAX is displayed, and the user inputs destination information via the destination input screen to give a print instruction. Accordingly, the FAX driver creates transmission data to be transmitted to the input destination, and controls the FAX device such that FAX transmission is performed.

When a version preceding Windows (trade mark) 8 of Microsoft (trade mark) is used as an OS, architecture referred to as a V3 printer driver is used. Further, when a version of Windows 8 or later is used, architecture referred to as a V4 printer driver can also be used. The V4 printer driver puts more emphasis on security as compared to the V3 printer driver, and thus customizability of the printer driver itself is reduced. As one example, the V4 printer driver is not capable of starting an arbitrary user interface (UI) after a print instruction is given. To compensate for such reduction in customizability, a vendor providing devices is capable of providing an application dedicated to assisting a function of the printer driver. Such an application is referred to as a Windows Store Device App (WSDA). Through provision of this WSDA, a vendor providing devices is capable of performing customization of a print setting screen or the like, and displaying an arbitrary UI (refer to Japanese Patent Laid-Open No. 2017-33052).

In the FAX driver supporting the architecture of the V4 printer driver, use of this WSDA allows the user to input destination information. Further, in the V4 printer driver, there is a rule that a print setting item for each job is handled with a format of an XML format that is referred to as a PrintTicket. Then, the destination information input in the FAX driver is embedded in the PrintTicket format. In this manner, the destination information is transferred from the WSDA to the V4 printer driver.

However, when the destination information is stored in the PrintTicket by using a print setting file for each job, there is a fear that the destination information included in the print setting may be transferred to a print source application. In this case, some print source applications may have the destination information embedded in user data of the applications to undesirably leak the destination information, depending on a configuration of the print source applications. Therefore, when a FAX driver is constituted by using the architecture of the V4 printer driver, it is an issue to prevent destination information that may be private information from being leaked, irrespective of a configuration of an application.

### SUMMARY OF THE INVENTION

An aspect of the present invention is to eliminate the above-mentioned problem with conventional technology.

A feature of the present invention is to provide a technique that prevents input destination information from being transferred to an application.

According to a first aspect of the present invention, there is provided a non-transitory computer-readable storage medium storing a transmission setting application, wherein the transmission setting application is associated with a driver that generates a transmission command for causing a device to transmit data received from an application to a destination, wherein the transmission setting application causes a computer to execute: a first input step of causing a user to input a transmission setting of the data; a reception step of receiving the data and the transmission setting from the application that has obtained the transmission setting; a second input step of causing the user to input information indicating the destination; and a providing step of providing the information indicating the input destination, the transmission setting, and the data to the driver.

According to a second aspect of the present invention, there is provided a method of controlling a computer such that a transmission setting to a driver is performed, the driver generates a transmission command for causing a device to transmit data received from an application to a destination, the method comprising: causing a user to input a transmission setting of the data; receiving the data and the transmission setting from the application that has obtained the transmission setting; causing the user to input information indicating the destination; and providing the information indicating the input destination, the transmission setting, and the data to the driver.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a configuration diagram of a FAX system according to a first embodiment of the present invention.

FIG. 2 is a diagram for explaining a functional configuration of a computer and a data flow of printing according to the first embodiment.

FIG. 3 is a diagram illustrating an example of a print setting UI displayed in an extended print application according to the first embodiment.

FIG. 4 is a diagram illustrating an example of a printing UI for printing of the extended print application according to the first embodiment.

FIG. 5 is a diagram illustrating an example of a PrintTicket of print settings according to the first embodiment.

FIG. 6 is a diagram illustrating an example of a PrintTicket of destination information according to the first embodiment.

FIG. 7 is a flowchart for explaining processing performed by a background task of the extended print application according to the first embodiment.

FIG. 8 is a flowchart for explaining processing performed by the printing UI of the extended print application according to the first embodiment.

FIG. 9 is a flowchart for explaining processing performed by a FAX driver according to the first embodiment.

FIG. 10 is a flowchart for explaining processing performed by an OS when printing is executed according to a second embodiment.

FIG. 11 is a flowchart for explaining processing performed by an installer of the FAX driver according to the second embodiment.

FIG. 12 is a flowchart for explaining processing performed by the FAX driver according to the second embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

Note that, in embodiments described below, one example of a device control program according to the present invention will be described taking an example of an extended print application (extended application program, extended application) 200, and one example of a communication device will be described taking an example of a computer 100.

### First Embodiment

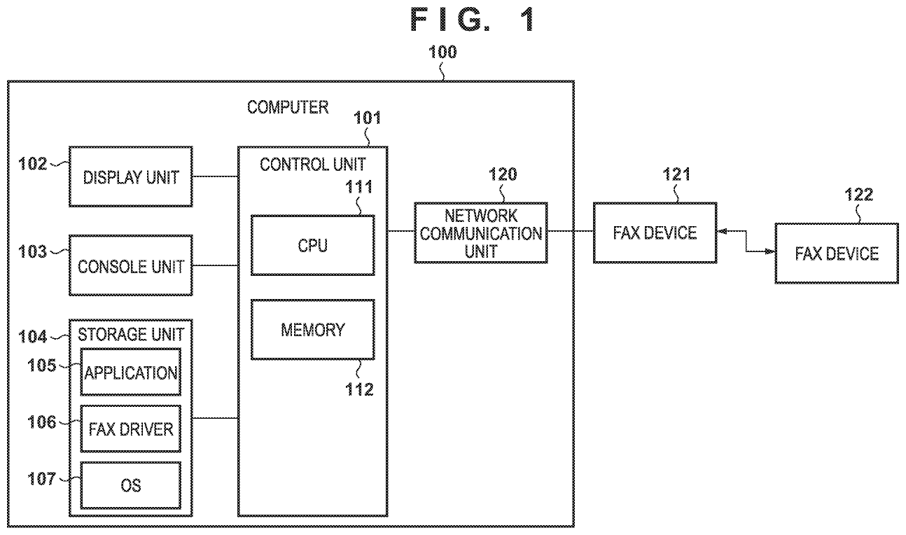

FIG. 1 is a configuration diagram of a FAX system according to the first embodiment of the present invention.

This system includes a computer 100, a sender facsimile device (FAX device) 121, and a FAX device 122 that is a recipient device. The computer 100 and the FAX device 121 are connected via a network. In FIG. 1, the computer 100 and the FAX device 121 are connected via a network. However, the computer 100 and the FAX device 121 may be connected via another connection mode, such as a USB connection. Network connection may adopt any sort of connection mode, such as a TCP/IP connection, a WSD connection, and an IPP connection. The sender FAX device 121 and the recipient FAX device 122 are connected via a FAX line. Although there are some types of FAX lines, such as a G3 line and a G4 line, the FAX line may adopt any sort of line as long as the line provides a relationship allowing FAX transmission and reception to and from each other.

In the computer 100, a control unit 101 including a CPU 111 and a memory 112 controls the overall computer 100. A display unit 102 represents a display device such as a display having a touch panel function, and a console unit 103 represents an input device such as a pointing device and a keyboard. A storage unit 104 stores software, such as an operating system (OS) 107, various applications (Apps) 105, and a FAX driver (driver program) 106. Those programs are deployed into the memory 112 as necessary, and are executed by the CPU 111. The OS 107 is a piece of software that manages basic operations of the computer 100. A network communication unit 120 performs input/output of data to/from an external device through connection with a network. Processing according to the embodiment illustrated in flowcharts to be described later is implemented in the following manner. Specifically, the CPU 111 deploys software stored in the storage unit 104 in the memory 112 of the control unit 101, and the CPU 111 executes the deployed program. Note that the CPU is an abbreviation for Central Processing Unit.

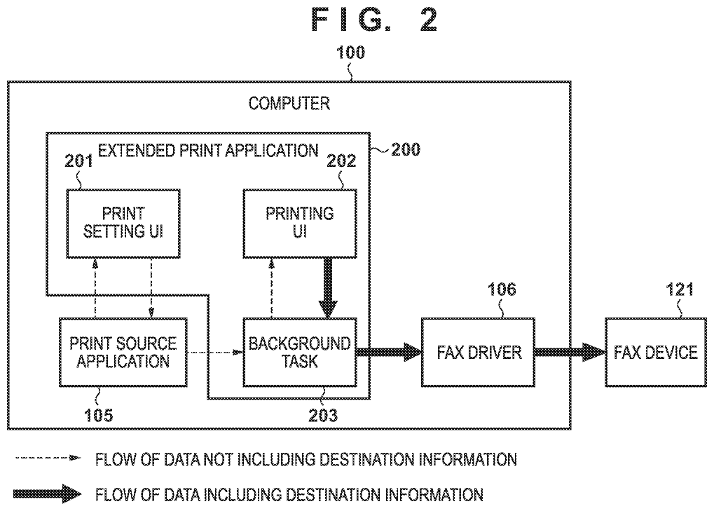

FIG. 2 is a diagram for explaining a functional configuration of the computer 100 and a data flow of printing according to the first embodiment. FIG. 2 illustrates the data flow in which a print source application 105 running in the computer 100 causes the FAX device 121 to perform FAX transmission through the FAX driver 106.

The print source application 105 is an arbitrary application installed in the computer 100. A printing function is a prerequisite for the print source application 105. The print source application 105 has a function of outputting arbitrary user data to an arbitrary printer queue. The printer queue refers to an individual instance of an installed printer driver. Generally, one printer queue corresponds to one physical device on a one-to-one basis. The first embodiment describes an example in which the print source application 105 is an application based on a format referred to as a Universal Windows Platform (UWP) application.

When a user gives an instruction of output processing from the print source application 105, a predetermined screen is displayed by a Modern Print Dialog (MPD) (not illustrated), which is a function of the OS 107. The screen provided by the MPD has a print preview function allowing checking of a printing result on a screen, and a function allowing a user to select basic print settings. The user is capable of changing the basic print settings by checking the print preview through the MPD of the OS 107. Further, in the MPD, the user is also capable of selecting which driver to use. The first embodiment gives description of a case where the user selects the FAX driver 106.

The FAX driver 106 is a type of a printer driver, and has a basic function equivalent to a function of the printer driver. The printer driver gives an instruction of printing print data to a connected print device, whereas the FAX driver 106 gives a FAX transmission instruction to a connected FAX device 121 such that the connected FAX device 121 transmits print data to another FAX device 122 by FAX transmission. In response to the FAX transmission instruction from the FAX driver 106, the FAX device 121 performs FAX transmission to a designated destination. At this time, the FAX device 121 outputs no printed materials. The FAX driver 106 is different from the printer driver in that the FAX driver 106 invariably notifies the FAX device 121 of destination information. As the OS 107, architecture referred to as a V4 printer driver in the computer 100 equipped with an OS of Windows 8 or later of Microsoft is a prerequisite for the FAX driver 106 according to the first embodiment.

The extended print application 200 is a special application installed in association with the FAX driver 106 in advance, and is referred to as a Windows Store Device Application (hereinafter WSDA). With the MPD that is a function of the OS 107 described above, the user is capable of changing only the basic print settings. With the use of the extended print application 200, however, the user is capable of performing more detailed print settings. Note that, although the extended print application 200 is associated with the FAX driver 106, the extended print application 200 is an independent application program. Therefore, when the extended print application 200 and a program of the FAX driver 106 are executed by the CPU 111, the extended print application 200 and the program of the FAX driver 106 are started as different processes.

More specifically, when an “other settings” button of a user interface (UI) of the MPD is pressed, a print setting UI 201 of the extended print application 200 is displayed by the OS 107. Generally, the extended print application 200 is an application allowing a vendor providing printers to extend a function of its providing printer driver. The print setting UI 201 of the extended print application 200 receives information indicating print settings from the MPD, changes the setting information according to user's operation, and returns the setting information to the MPD. Here, the information indicating print settings is described in an XML format based on a form defined by the OS 107, and is included in data referred to as a PrintTicket. The print setting UI 201 of the extended print application 200 is capable of referring to and changing a PrintTicket, but is not capable of referring to drawing data (such as image data and text information providing the base of printing of an image on a paper surface). Further, the print setting UI 201 of the extended print application 200 is started only when the user presses the “other settings” button on a print setting screen provided by the MPD, and is not necessarily invariably started when print settings are performed.

When detailed print settings are specified in the print setting UI 201 of the extended print application 200, and then a “print” button is pressed on the setting screen provided by the MPD of the OS 107, a print request made in the MPD is issued. When an instruction of printing is given by the user on the MPD, the print source application 105 receives the request from the MPD, and then generates print data necessary for printing. The print data is stored in an XPS document described in a form referred to as an XML Paper Specification (hereinafter XPS). This XPS document stores both of the print data and the PrintTicket described above. In the first embodiment, drawing data generated by the print source application 105 is referred to as print data, and is expressed separately from a PrintTicket.

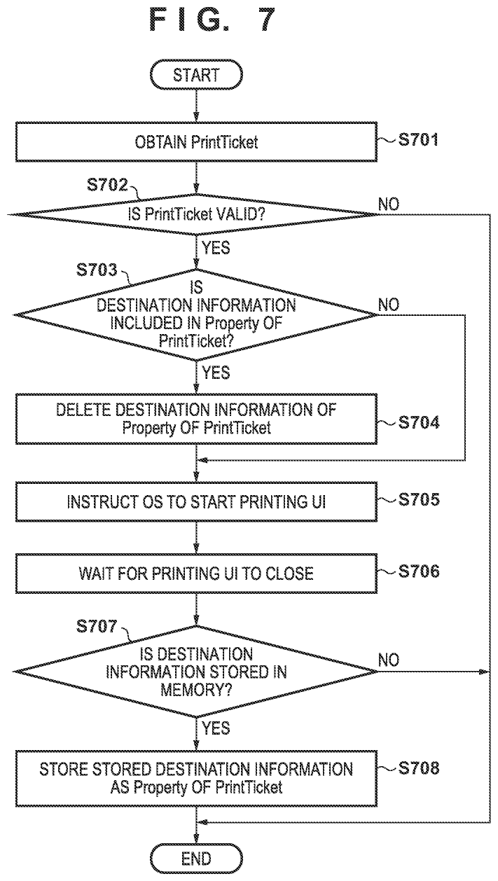

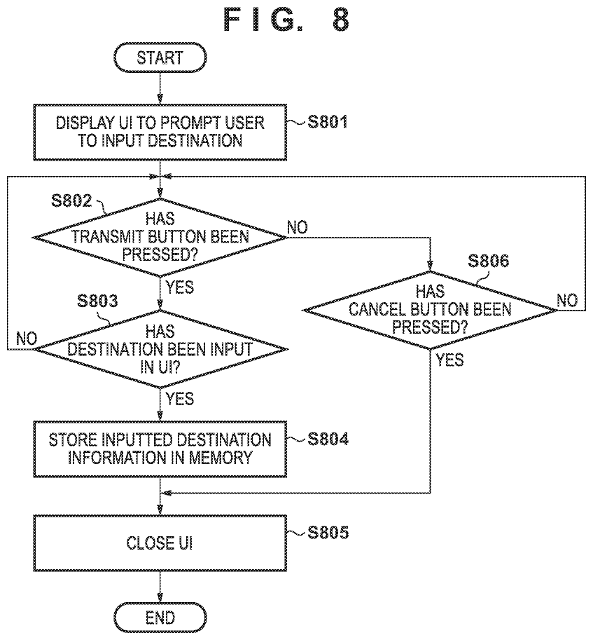

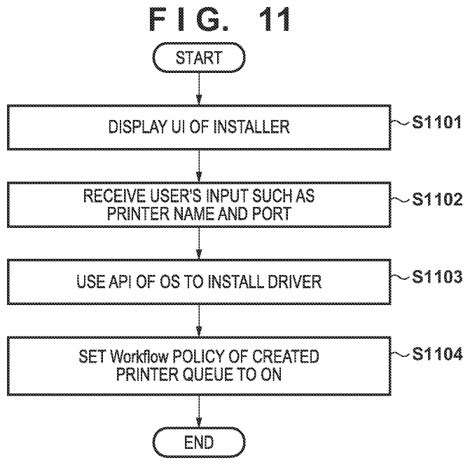

The PrintTicket and the print data generated by the print source application 105 are transferred again to the extended print application 200 by the OS 107. Actually, the OS 107 determines whether to transfer or not to transfer the PrintTicket and the print data to the extended print application 200. Details of this determination will be described later with reference to FIG. 10. The PrintTicket and the print data are transferred to a background task 203 of the extended print application 200. The PrintTicket received in the background task 203 is transferred to a printing UI 202 for printing. Actually, the background task 203 determines whether to start the printing UI 202. Details of this determination will be separately described later with reference to FIG. 7.

The background task 203 and the printing UI 202 of the extended print application 200 are collectively referred to as a Print Workflow App. The Print Workflow App is a term for a function of the extended print application 200. Generally, the Print Workflow App can perform print settings after execution of printing, and editing of print data. An arbitrary UI can be displayed after a print instruction on the MPD is given by the printing UI 202, and the background task 203 is capable of editing the PrintTicket and the print data, based on settings specified in the arbitrary UI. In the printing UI 202 according to the first embodiment, FAX destination information can be input. The input destination information is embedded in the PrintTicket by the background task 203. The PrintTicket edited by the background task 203 and the print data generated by the print source application 105 are transferred to the FAX driver 106 by the OS 107 as a spool file.

When the FAX driver 106 obtains the PrintTicket and the print data, the FAX driver 106 converts the PrintTicket and the print data into a command that can be interpreted by the FAX device 121. More specifically, the FAX driver 106 rasterizes the print data, and performs gray scale conversion and a halftone process on the print data. In this manner, the FAX driver 106 compresses the print data into a Modified Modified Read (MMR) format that can be interpreted by the FAX device 121. Further, the FAX driver 106 also converts the PrintTicket destination information into a format that can be interpreted by the FAX device 121. The FAX driver 106 attaches the converted PrintTicket destination information to the print data in the MMR format, and transmits the data to the FAX device 121 as PDL data. The FAX device 121 interprets received PDL data, and transmits the print data in the MMR format to the designated destination by FAX transmission.

Regarding flows of each type of data, FIG. 2 distinguishably illustrates a flow of data not including destination information and a flow of data including destination information. All pieces of data input/output to/from the print source application 105 do not include destination information. Data including destination information is only data obtained after the printing UI 202 is started after the “print” button of the MPD is pressed. Preparation of such a flow of data enables prevention of destination information from being transferred to the print source application 105.

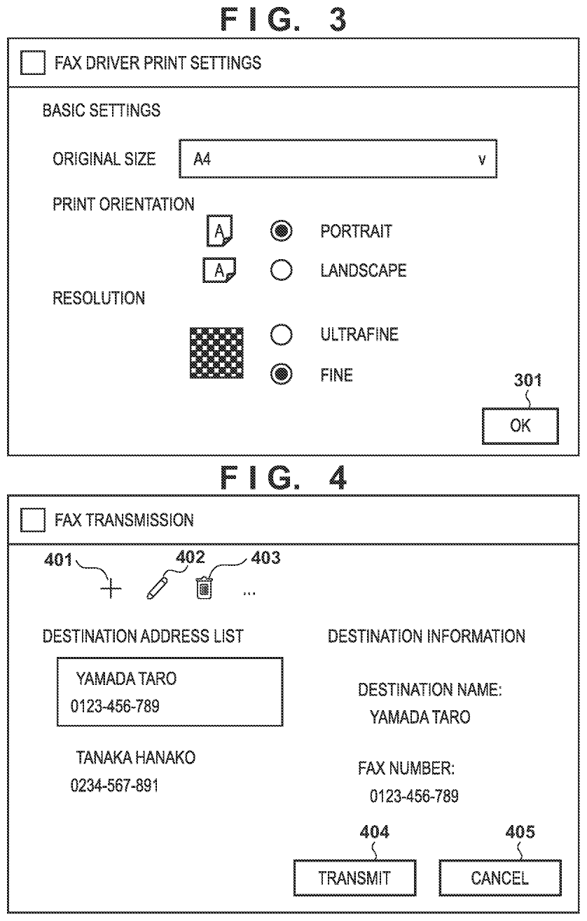

Next, with reference to FIG. 3 and FIG. 4, UIs of the extended print application 200 will be described.

FIG. 3 is a diagram illustrating an example of the print setting UI 201 displayed in the extended print application 200 according to the first embodiment.

The print setting UI 201 according to the first embodiment can specify original size, print orientation, and resolution. When a lower right OK button 301 is pressed, a screen is switched back to the print setting screen (not shown) of the MPD described above. Note that the print setting UI 201 of the extended print application 200 according to the first embodiment has a feature in that more detailed settings can be performed as compared to the MPD. Therefore, the print setting UI 201 may allow more types of print settings (such as settings of a cover sheet and layout designation) than those in the screen illustrated in FIG. 3. Note that, in the print setting UI 201 according to the first embodiment, input of destination information that is a FAX transmission destination is not accepted.

Generally, the PrintTicket edited in the print setting UI 201 of the extended print application 200 may be undesirably transferred to the print source application 105. The PrintTicket that has been undesirably transferred to the print source application 105 may be reused in subsequent printing, and this may possibly cause mistaken transmission in a case of FAX transmission. Further, destination information may be possibly stored in user data of the print source application 105, together with print settings. Since the destination information may be private information, storing the destination information in user data should be avoided, unlike general print settings. Consequently, the first embodiment has a configuration in which input of destination information in the print setting UI 201 is not allowed. With this configuration, the first embodiment achieves an effect that destination information can be prevented from being stored in a print setting file that can be accessed from an application.

FIG. 4 is a diagram illustrating an example of the printing UI 202 of the extended print application 200 according to the first embodiment.

Destination information cannot be input in the print setting UI 201 described above; however, destination information can be input in the printing UI 202, instead. The user is capable of pressing an “add (+ mark)” button 401 of the printing UI 202 to input arbitrary information of a destination to which the user intends to perform FAX transmission. Here, a plurality of pieces of destination information can be input, and the same print data can be broadcast to a plurality of destinations. Performing FAX transmission to a plurality of destinations is referred to as broadcasting.

Further, in the first embodiment, although not illustrated, an address book function may be provided, such that a destination registered in an address book in advance can be easily added as destination information. Besides, in the printing UI 202, when an “edit (pencil mark)” button 402 is pressed, input destination information can be edited. Further, when a “delete (dust box mark)” button 403 is pressed, input destination information can be deleted as well. The destination information input in the printing UI 202 is separately reflected on the PrintTicket by the background task 203. Note that the printing UI 202 may be simpler; for example, the printing UI 202 may be a UI in which only a FAX number of a destination is directly input. When a lower right “transmit” button 404 is pressed after the user inputs a destination via this UI, FAX transmission is performed by the FAX device 121. In contrast, when the user presses a “cancel” button 405, this FAX job is cancelled. Further, other destination information, which cannot be input in the print setting UI 201, can be input in the printing UI 202 as well. More specifically, for example, a contact mail address used for receiving a notification of completion of a job in Fax transmission can be set in the printing UI 202.

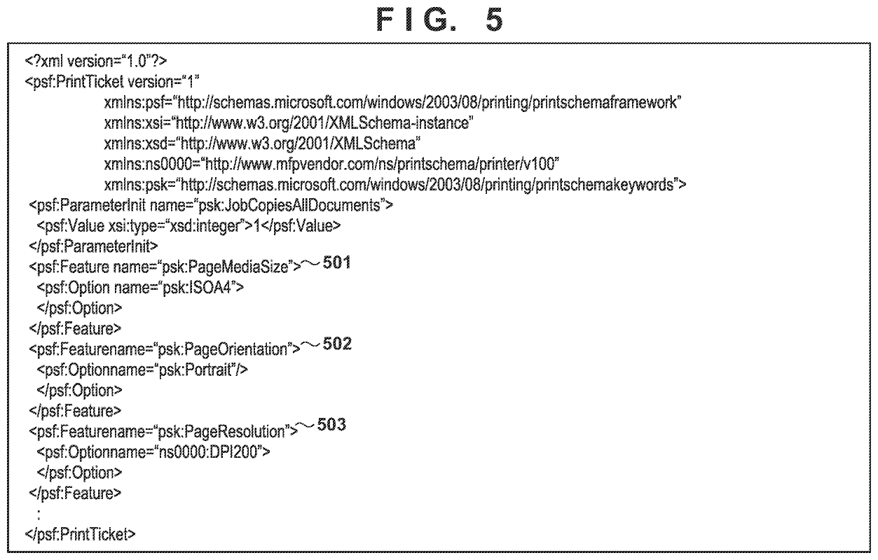

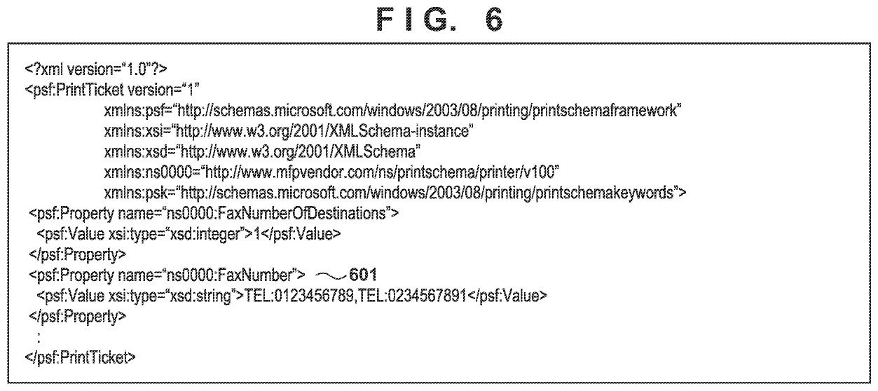

Next, with reference to FIG. 5 and FIG. 6, a PrintTicket edited by the extended print application 200 will be described.

FIG. 5 is a diagram illustrating an example of a PrintTicket of a print setting file according to the first embodiment. FIG. 5 depicts a view illustrating an example of a PrintTicket generated by the extended print application 200, based on print settings specified in the print setting UI 201 illustrated in FIG. 3.

A setting corresponding to the original size (“A4” in FIG. 3) in the print setting UI 201 is “PageMediaSize” 501 registered as a Feature. Similarly, settings corresponding to the print orientation (“portrait” in FIG. 3) and the resolution (“fine” in FIG. 3) in the print setting UI 201 are respectively “PageOrientation” 502 and “PageResolution” 503 each registered as a Feature. In this manner, each of the print settings specified in the print setting UI 201 is registered in the PrintTicket and is transferred. Note that the first embodiment has a feature in that destination information indicating a FAX transmission destination is not included in the PrintTicket of FIG. 5.

FIG. 6 is a diagram illustrating an example of a PrintTicket of destination information according to the first embodiment. FIG. 6 illustrates an example of a PrintTicket generated by the extended print application 200, based on the destination information input in the printing UI 202 illustrated in FIG. 4.

The destination information (telephone number) input in the printing UI 202 of FIG. 4 is stored in a PrintTicket as “FaxNumber” 601 of Property information. The first embodiment has a feature in that the PrintTicket including destination information is present only in a data flow after the printing UI 202 of the extended print application 200 is displayed.

Next, with reference to flowcharts of FIG. 7 to FIG. 9, a Print Workflow App of the extended print application 200 and processing of the FAX driver 106 according to the first embodiment will be described. As described above, the Print Workflow App includes the background task 203 and the printing UI 202, and thus those will be described in separate flowcharts. Note that all of processing flows of the first embodiment are implemented in the following manner. Specifically, software stored in the storage unit 104 is deployed in the memory 112, and is executed by the CPU 111. Therefore, following description with the flowcharts is given assuming that the subject that performs the processing of each processing step is the CPU 111.

FIG. 7 is a flowchart for explaining processing performed by the background task 203 of the extended print application 200 according to the first embodiment.

The background task 203 is started when the “print” button of the MPD is pressed. When the background task 203 is started, first, in step S701, the CPU 111 obtains a PrintTicket, which is print setting information in the present print processing. Subsequently, the processing proceeds to step S702. The CPU 111 checks validity of the obtained PrintTicket. This is because, in some rare cases, a wrong PrintTicket may be delivered from the print source application 105, or a PrintTicket may be empty. When the CPU 111 determines that the PrintTicket is not valid, the CPU 111 ends the processing.

When the CPU 111 determines that the PrintTicket is valid in step S702, the processing proceeds to step S703, and the CPU 111 determines whether or not destination information is included in Property of the PrintTicket. Usually, destination information is not included at this stage. When the destination information is included for some unknown reason, however, the processing proceeds to step S704, and the CPU 111 deletes the destination information, and then the processing proceeds to step S705. On the other hand, when the destination information is not included, the processing also proceeds to step S705.

In step S705, the CPU 111 instructs the OS 107 to start the printing UI 202. Note that, when the destination information is included in the PrintTicket in step S703, the CPU 111 may instruct the OS 107 not to start the printing UI 202.

In the first embodiment, for the purpose of preventing mistaken FAX transmission, the printing UI 202 is invariably displayed after the “print” button of the MPD is pressed. For this reason, the CPU 111 unconditionally instructs the OS 107 to start the printing UI 202 in step S705. Then, the processing proceeds to step S706, and the CPU 111 waits for the printing UI 202 to be closed. Then, the processing proceeds to step S707. In step S707, the CPU 111 determines whether or not the destination information is stored in a predetermined memory. As will be described later, all pieces of destination information input by the user via the printing UI 202 are stored in the predetermined memory. The memory is reserved for each print job. Therefore, the destination information input by the user can be referred to by the background task 203, without conflicting with another job. When the CPU 111 determines in step S707 that the destination information is stored in the memory, the processing proceeds to step S708, and the CPU 111 stores the destination information as Property information of the PrintTicket. Then the CPU 111 ends the processing. The PrintTicket after the processing of step S708 ends is transferred to the FAX driver 106 by the OS 107 as a spool file.

FIG. 8 is a flowchart for explaining processing performed by the printing UI 202 of the extended print application 200 according to the first embodiment. When the printing UI 202 is instructed to be started by the background task 203 in step S705 of FIG. 7, the OS 107 starts the printing UI 202 to thereby start the processing.

First, the CPU 111 executing the printing UI 202 started in step S801 displays the UI illustrated in FIG. 4, for example, to prompt the user to input destination information that is a FAX transmission destination. Next, in step S802, the CPU 111 determines whether or not the user has pressed the “transmit” button 404. When the CPU 111 determines that the “transmit” button 404 has been pressed, the processing proceeds to step S803. In step S803, the CPU 111 determines whether or not the destination information is input in the UI as shown in FIG. 4. When the destination information is not input, the CPU 111 notifies the user that the destination information is not input. Then, the processing proceeds to step S802, and the CPU 111 again waits for the “transmit” button 404 to be pressed.

When the CPU 111 determines in step S803 that the destination information is input, the processing proceeds to step S804, and the CPU 111 stores all pieces of the destination information input in the UI in the predetermined memory described above. As described above, the memory is reserved for each print job. Therefore, the destination information input by the user can be stored, without conflicting with another job. Then, the processing proceeds to step S805, and the CPU 111 closes the UI and ends the processing.

On the other hand, when the “transmit” button 404 is not pressed in step S802, the processing proceeds to step S806, and the CPU 111 determines whether or not the “cancel” button 405 has been pressed. When the CPU 111 determines that the “cancel” button 405 has been pressed, the processing proceeds to step S805. In step S805, irrespective of whether the destination information is input in the UI, the CPU 111 closes the UI, and ends the processing. Further, when the CPU 111 determines in step S806 that the “cancel” button 405 has not been pressed, the processing proceeds to step S802, and the CPU 111 again waits for the “transmit” button 404 to be pressed.

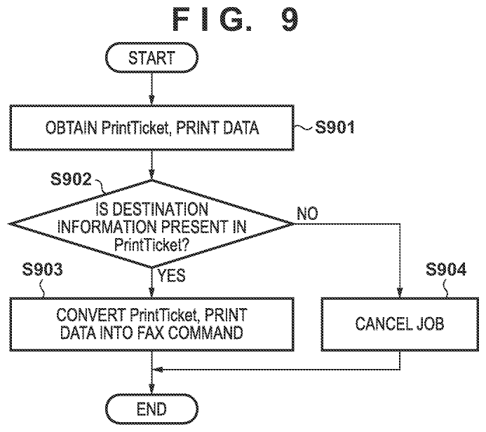

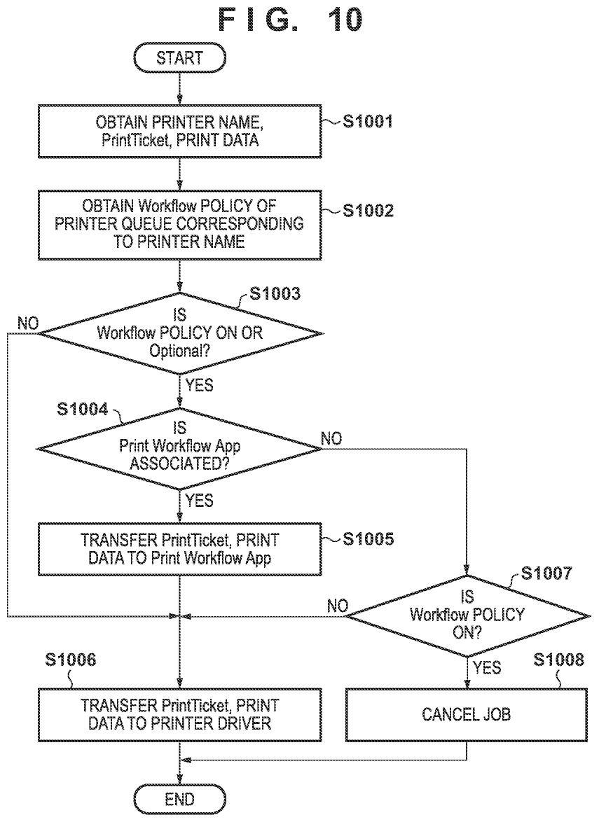

FIG. 9 is a flowchart for explaining processing performed by the FAX driver 106 according to the first embodiment. The FAX driver 106 is started by the OS 107 after the background task 203 ends.

When the FAX driver 106 is started, first, in step S901, the CPU 111 obtains a PrintTicket and print data from a spool file. Next, the processing proceeds to step S902, and the CPU 111 determines whether or not the destination information is present as Property of the PrintTicket. At this time, when the CPU 111 determines that the destination information is present in the PrintTicket, the processing proceeds to step S903, and the CPU 111 converts the PrintTicket and the print data into a FAX command that can be interpreted by the FAX device 121, and then ends the processing. Note that this FAX command may adopt any format as long as the FAX device 121 can interpret the format. On the other hand, when the CPU 111 determines in step S902 that the destination information is not present in the PrintTicket, the printing UI 202 may not be started after pressing on the “print” button of the MPD for some unknown reason. Thus, the processing proceeds to step S904, and the CPU 111 cancels the job, and ends the processing.

The FAX driver 106 according to the first embodiment rasterizes the print data, converts the print data into a gray scale, performs a halftone process on the print data, and then performs MMR compression. Further, the FAX driver 106 converts the destination information into a format that can be interpreted by the FAX device 121, and combines the converted information with the MMR data to generate a FAX command. The FAX command generated by the FAX driver 106 in this manner is sent by the OS 107 to the FAX device 121 that is a connection destination.

The FAX device 121, which has received the FAX command from the FAX driver 106, transmits a FAX to a designated address (here, destination of the recipient FAX device 122) via the FAX line.

When FAX transmission according to the first embodiment is performed, the printing UI 202 is invariably displayed. Therefore, mistaken FAX transmission made by the user to an unintended destination can be prevented. Note that, after being converted into the FAX command, the PrintTicket including the destination information is discarded by the FAX driver 106.

As described above, according to the first embodiment, destination information indicating a transmission destination is not transferred to the print source application 105. Therefore, destination information of a transmission destination that may be private information can be prevented from being leaked together with application data. Further, destination information indicating a contact mail address that is a transmission destination of a notification of completion of a job is not transferred to the print source application 105 either. Therefore, an e-mail address that may be private information can be prevented from being leaked together with application data. Further, since destination information indicating a transmission destination is not transferred to the print source application 105, when an instruction of performing FAX transmission based on application data is received again, mistaken transmission to a previously set destination can be prevented.

### Second Embodiment

For the sake of simplification of description, the first embodiment described above gives description that the OS 107 invariably starts the Print Workflow App when printing is performed. In contrast, a second embodiment gives description taking the following example. Specifically, processing in consideration of an execution policy related to the Print Workflow App of the OS 107 is performed, as well as the processing of first embodiment. Prior to giving the description of the second embodiment, processing of the OS 107 after the “print” button is pressed in the MPD will be described rather more in detail with reference to FIG. 10. Note that configurations of a FAX system, a computer 100, and the like, according to the second embodiment are similar to those of the first embodiment described above, and thus description thereof will be omitted.

FIG. 10 is a flowchart for explaining processing performed by the OS 107 when printing is executed according to the second embodiment.

When the “print” button is pressed in the MPD, first, in step S1001, the CPU 111 obtains a printer name of a printer queue specified in the MPD, and a PrintTicket and print data of the present printing. Next, the processing proceeds to step S1002, and the CPU 111 obtains a Workflow policy of the printer queue corresponding to the printer name. The Workflow policy is attribute information set for each printer queue of an installed printer driver, and is managed by the OS 107. The Workflow policy has any one value among three values of “ON,” “OFF,” and “Optional.” When the Workflow policy obtained in step S1002 is neither “ON” nor “Optional” in step S1003, the processing proceeds to step S1006, and the CPU 111 transfers the PrintTicket and the print data to the printer driver without starting the Print Workflow App, and then ends the processing. Note that, here, general behavior of the OS 107 is expressed as a printer driver. In the second embodiment, however, the general behavior of the OS 107 refers to the FAX driver 106.

On the other hand, when the Workflow policy is either “ON” or “Optional” in step S1003, the processing proceeds to step S1004, and the CPU 111 determines whether or not a Print Workflow App is associated with the specified printer queue. As described above, in the second embodiment, the Print Workflow App is one function of the extended print application 200. Therefore, actually, the CPU 111 determines whether or not the extended print application 200 is associated with the specified printer queue. When the CPU 111 determines that the Print Workflow App is associated, the processing proceeds to step S1005, and the CPU 111 starts the associated Print Workflow App, and transfers the PrintTicket and the print data to the Print Workflow App. After that, when the background task 203 of the Print Workflow App ends, the processing proceeds to step S1006, and the CPU 111 transfers the PrintTicket and the print data edited by the background task 203 to the relevant printer driver, and then ends the processing.

On the other hand, when the CPU 111 determines in step S1004 that the Print Workflow App is not associated, the processing proceeds to step S1007, and the CPU 111 determines whether or not the Workflow policy that has just been obtained is “ON.” When the CPU 111 determines that the Workflow policy is “ON,” the processing proceeds to step S1008, and the CPU 111 cancels the job, and ends the processing. On the other hand, when the Workflow policy is not “ON” in step S1007, i.e., when the Workflow policy is “Optional,” the processing proceeds to step S1006, and the CPU 111 transfers the PrintTicket and the print data to the printer driver without canceling the job, and then ends the processing.

The following describes summarized operation of the above. When the Workflow policy is “ON,” the OS 107 ensures that the Print Workflow App is invariably used when a printer driver is started. Further, when the Workflow policy is “OFF,” the OS 107 ensures that the Print Workflow App is invariably not used when a printer driver is started. Further, when the Workflow policy is “Optional,” the OS 107 ensures that the Print Workflow App is used only when the Print Workflow App is associated when a printer driver is started. Note that the Workflow policy immediately after installation of a printer driver is “Optional” by default. In this manner, the OS 107 is capable of controlling whether or not to start the Print Workflow App for each of all installed printer queues, based on the Workflow policy.

To prevent FAX transmission to a destination unintended by the user, the FAX driver 106 according to the second embodiment needs to invariably start the printing UI 202 after the “print” button of the MPD is pressed. In this case, it is desirable that the Workflow policy be “ON.” Even when the Workflow policy is “Optional,” the printing UI 202 is invariably started on the condition that the Print Workflow App is associated. However, when the Print Workflow App is not associated, a job is also undesirably transferred to the FAX driver 106. When the Workflow policy is “ON,” the OS 107 cancels the job when the Print Workflow App is not associated. The OS 107 and the print source application 105 are explicitly notified of the cancellation, and thus subsequent processing can be delegated to the OS 107 and the print source application 105.

Next, description is given of a difference between a case where the FAX driver 106 cancels a job and a case where the OS 107 cancels a job, when the Print Workflow App is not associated.

The FAX driver 106 is prohibited from displaying a UI when the FAX driver 106 is executed. Therefore, when a print job is cancelled, it is difficult for the FAX driver 106 to notify a user that a print job is cancelled. For this reason, in some cases, the user may not be aware that the print job has been cancelled. In contrast, when the OS 107 cancels a print job, because the OS 107 is arranged to notify the print source application 105 of cancellation of the print job, the OS 107 is capable of explicitly giving notice that printing of the print job has been cancelled on a screen of the print source application 105. For this reason, when a print job is cancelled, cancellation when the Workflow policy is “ON” is more desirable than cancellation when the Workflow policy is “Optional.”

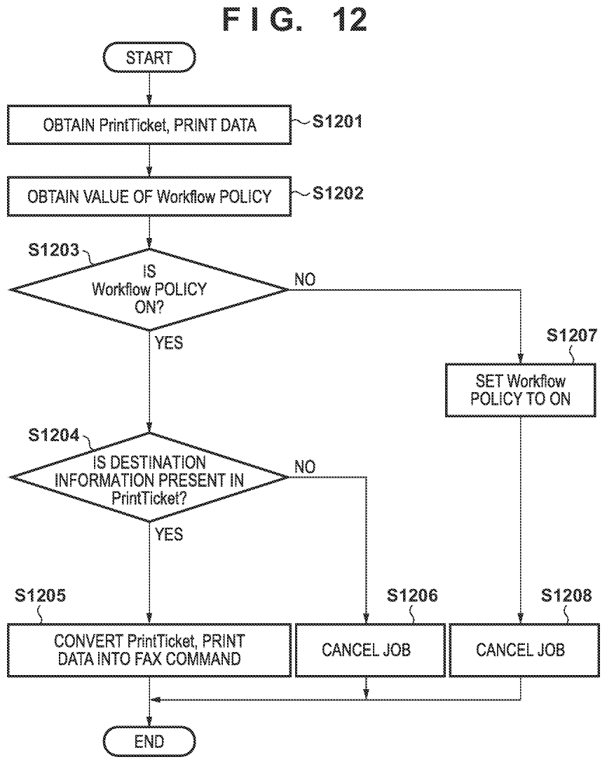

To set the Workflow policy to “ON,” the second embodiment gives description of two methods, i.e., a method of using an installer program of the FAX driver 106 and a method of using the FAX driver 106 itself, respectively with reference to FIG. 11 and FIG. 12. At the time of execution, both the methods may be executed, or either one of the methods may be executed. Note that all of processing illustrated in the flowcharts of FIG. 11 and FIG. 12 are implemented in the following manner. Specifically, software stored in the storage unit 104 is deployed in the memory 112, and the deployed program is executed by the CPU 111.

FIG. 11 is a flowchart for explaining processing performed by an installer program of the FAX driver 106 according to the second embodiment.

A user is capable of installing the FAX driver 106 according to the second embodiment by using a function of the OS 107; however, the user is also capable of installing the FAX driver 106 by using an installer program dedicated to installation.

When an installer program of the FAX driver 106 is explicitly started by the user, in step S1101, the CPU 111 executing the installer program displays a UI of the installer program. Then, the processing proceeds to step S1102, and the CPU 111 accepts a user's input of information necessary for installation, such as a printer name and information of a connected port of the FAX driver 106 to be installed. Note that the UI of the installer program is not particularly different from a UI of an installer program of an existing printer driver, and thus description thereof will be omitted.

Then, after all pieces of information necessary for installation are gathered, the processing proceeds to step S1103, and the CPU 111 uses an API of the OS 107 to install the driver. In this manner, a printer queue with a specified printer name is created by the OS 107. The processing described in the above is not different from processing of an installer program of an existing printer driver. Next, the processing proceeds to step S1104, and the CPU 111 sets a Workflow policy of the created printer queue to “ON,” and then ends the processing of the installer program. Since the Workflow policy immediately after the installation is “Optional” by default, the Workflow policy is changed to “ON” in step S1104.

The installer program of the FAX driver 106 executes the processing illustrated in this flowchart in this manner, and thus the user is capable of using the FAX driver 106 with the Workflow policy set to “ON” from the first time the user uses the FAX driver 106.

FIG. 12 is a flowchart for explaining processing performed by the FAX driver 106 according to the second embodiment.

The first embodiment described above gives description up to processing that the FAX driver 106 converts the PrintTicket and the print data into a FAX command that can be interpreted by the FAX device 121 with reference to FIG. 9. In the second embodiment, processing of setting the Workflow policy to “ON” is added to this processing. FIG. 12 illustrates the processing.

When the FAX driver 106 is started, first, in step S1201, the CPU 111 obtains a PrintTicket and print data. Next, the processing proceeds to step S1202, and the CPU 111 obtains a value of the Workflow policy of its own from OS 107. Then, the processing proceeds to step S1203, and the CPU 111 determines whether or not the Workflow policy is “ON.” When the Workflow policy is “ON,” the processing proceeds to step S1204. In step S1204 to step S1206, processing the same as the processing of step S902 to step S904 of FIG. 9 described above is performed.

On the other hand, when the CPU 111 determines in step S1203 that the Workflow policy is not “ON,” i.e., when the CPU 111 determines that the Workflow policy is “OFF” or “Optional,” the processing proceeds to step S1207. In step S1207, the CPU 111 uses an API of the OS 107 to set the Workflow policy of its own to “ON.” Then, the processing proceeds to step S1208, and the CPU 111 cancels the present job, and ends the processing.

Adding the processing as described above enables such control that the Workflow policy is invariably set to “ON” from the next time, when the FAX driver 106 issues a print job.

Note that, when the FAX driver 106 is installed by using an installer program that executes the processing of FIG. 11, the Workflow policy is invariably “ON.” Note that, when the FAX driver 106 is installed without using an installer program or when the environment is a client environment of a shared printer, for example, the FAX driver 106 may be installed with the Workflow policy remaining as “Optional.” Even in such cases, when the Workflow policy is set to “ON” by the FAX driver 106 that executes the processing of FIG. 12, the Workflow policy being set to “ON” can be more securely ensured.

Further, to securely set the Workflow policy to “ON,” processing of setting the Workflow policy to “ON” may be performed when the print setting UI 201 is started.

The first and second embodiments of the present invention are described in the above. The first and second embodiments described above give description taking an example in which a Print Workflow App of a WSDA is used as an extended user interface. However, implementation is also possible by using another type of extended software.

Further, although not described in the first and second embodiments, an application referred to as Printer Extension is also present in the print setting UI adopting the architecture of the V4 printer driver. Processing, which is similar to a part of the processing described as being performed in the print setting UI 201 in the first and second embodiments, can also be performed in the Printer Extension.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-150642, filed Aug. 9, 2018, which is hereby incorporated by reference herein in its entirety.

What is claimed is:

1. A non-transitory computer-readable storage medium storing a transmission setting application, wherein the transmission setting application is associated with a driver that generates a transmission command for causing a device to transmit data received from an application to a destination,
wherein the transmission setting application causes a computer to execute:
a first input step of causing a user to input a transmission setting of the data;
a reception step of receiving the data and the transmission setting from the application that has obtained the transmission setting;
a second input step of causing the user to input information indicating the destination; and
a providing step of providing the information indicating the input destination, the transmission setting, and the data to the driver.

2. The non-transitory computer-readable storage medium according to claim 1, wherein the information indicating the destination is provided to the driver without being obtained by the application.

3. The non-transitory computer-readable storage medium according to claim 1, wherein, in the second input step, the user is caused to input the information indicating the destination after the application has obtained the transmission setting.

4. The non-transitory computer-readable storage medium according to claim 1, further comprising:
a display step of displaying a setting screen for causing the user to input the information indicating the destination after the application has obtained the transmission setting.

5. The non-transitory computer-readable storage medium according to claim 1, further comprising a step of displaying a setting screen for causing the user to input the transmission setting of the data, the setting screen being started in response to pressing on a button for performing another setting in a setting screen provided by an OS, the displaying being performed by the transmission setting application.

6. A method of controlling a computer such that a transmission setting to a driver is performed, the driver generates a transmission command for causing a device to transmit data received from an application to a destination, the method comprising:
causing a user to input a transmission setting of the data;
receiving the data and the transmission setting from the application that has obtained the transmission setting;
causing the user to input information indicating the destination; and
providing the information indicating the input destination, the transmission setting, and the data to the driver.

7. The method according to claim 6, wherein the information indicating the destination is provided to the driver without being obtained by the application.

8. The method according to claim 6, wherein, in the causing the user to input the information indicating the destination, the user is caused to input the information indicating the destination after the application has obtained the transmission setting.

9. The method according to claim 6, further comprising:
displaying a setting screen for causing the user to input the information indicating the destination after the application has obtained the transmission setting.

10. The method according to claim 6, further comprising:
displaying a setting screen for causing the user to input the transmission setting of the data, the setting screen is started in response to pressing on a button for performing another setting in a setting screen provided by an operating system (OS).

11. A non-transitory computer-readable storage medium storing a device control program, wherein the device control program includes a driver program and an extended application, the driver program generates transmission data based on drawing data generated in an application, the extended application is associated with the driver program,
wherein the extended application causes a computer to execute:
a display step of displaying an input screen for causing a user to input destination information of a reception device, in accordance with an instruction of the user performing output processing using the driver program;
a storing step of storing the destination information input via the input screen in a memory; and
a storing step of storing the destination information stored in the memory in a print setting file to be transmitted to the driver program, and
wherein the driver program causes the computer to execute:
a transmission step of generating a job and transmitting the job, the job includes transmission data to be transmitted to the reception device and destination information of the reception device, the job is generated based on drawing data generated in the application and the print setting file storing the destination information transmitted from the extended application,
wherein the extended application performs control such that the destination information set via the input screen is not included in the print setting file accessible from the application.

12. The non-transitory computer-readable storage medium according to claim 11, wherein the instruction of the user is given via a predetermined screen provided by an operating system (OS), and the user is further capable of changing a predetermined print setting in the predetermined screen.

13. The non-transitory computer-readable storage medium according to claim 12, wherein the predetermined screen is a Modern Print Dialog (MPD) provided by the OS.

14. The non-transitory computer-readable storage medium according to claim 13, wherein the extended application is started by the OS, in response to an instruction of printing has been given via the MPD.

15. The non-transitory computer-readable storage medium according to claim 11, wherein, in the storing step, the computer is caused to store the destination information in Property of a PrintTicket indicating the print setting file.

16. The non-transitory computer-readable storage medium according to claim 15, wherein, when destination information is already stored in the Property of the PrintTicket received in accordance with the fact that the instruction of the user has been given, the extended application causes the computer to execute deletion processing of deleting the stored destination information.

17. The non-transitory computer-readable storage medium according to claim 11, wherein, when the destination information is not stored in the print setting file, the driver program cancels execution of the job.

18. The non-transitory computer-readable storage medium according to claim 11, wherein the extended application is implemented in a Print Workflow App.

19. The non-transitory computer-readable storage medium according to claim 12, wherein, when attribute information set for each printer queue of the driver program is set to a start setting of starting the display step provided by the extended application, the OS starts the extended application, in response to an instruction of the user performing the output processing using the driver program.

20. The non-transitory computer-readable storage medium according to claim 19, wherein, when the attribute information is not set to the start setting, the driver program cancels the job, and changes the attribute information to the start setting.
